(19) United States
(12) Patent Application Publication
(10) Pub. No.: US 2005/0083547 A1
(43) Pub. Date: Apr. 21, 2005

(54) Image forming apparatus

(75) Inventors: Yoshiomi Hamano, Yamatokoriyama-shi (JP); Akihiko Taniguchi, Yamatokoriyama-shi (JP); Akira Tamagaki, Nara-shi (JP); Junichi Kajiwara, Nara-shi (JP); Takao Horiuchi, Nara-shi (JP); Kiyoshi Inoue, Nara-shi (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 10/970,306

(22) Filed: Oct. 20, 2004

(30) Foreign Application Priority Data
Oct. 20, 2003 (JP) P2003-359431

(51) Int. Cl. G06F 3/12; H04L 9/32; G06F 1/32; G06F 13/00

(52) U.S. Cl. 358/1.13; 713/202; 713/320; 358/1.16

(57) ABSTRACT

An image forming apparatus includes: a communications interface operative to receive a first image information item transmitted from terminal equipment connected thereto via a network; a storage section operative to store the first image information item therein; and an image reading section operative to obtain a second image information item by scanning an image of a document. The image forming apparatus further includes: a control section operative to compare the second image information item to the first image information item and then select the first image information item to be served for image forming if the second image information item is judged to be same as the first image information item, or the second image information item to be served for image forming if the second image information item is judged to be different from the first image information item.

### CROSS REFERENCE

This Nonprovisional application claims priority under 35 U.S.C. § 119(a) on Patent Application No. 2003-359431 filed in Japan on Oct. 20, 2003, the entire contents of which are hereby incorporated by reference.

### BACKGROUND OF THE INVENTION

1. Field of the Invention

The present invention relates to image forming apparatus and more particularly to such image forming apparatus which can form both an image based on image information transmitted from terminal equipment connected thereto through a network and an image based on image information obtained by scanning of the image of a document.

2. Description of the Related Art

Conventionally, there are digital image forming apparatus and analog image forming apparatus. The analog image forming apparatus are of the type wherein a document image is irradiated with light emitted from a light source lamp and then light reflected by the document image is guided to an image forming section via a reflecting mirror, through-lens, and the like to form an image. On the other hand, the digital image forming apparatus are of the type wherein light emitted from a light source lamp and then reflected by an document image is guided to a CCD sensor via a reflecting mirror, through-lens and the like and then received and read thereby as image information in a scanner section and the image information thus read in the scanner section is subjected to image processing by a control section and then transmitted to an image forming section to form an image.

As described above, the analog image forming apparatus are designed to form an image by directly transferring image information read to the image forming section, in contrast to the digital image forming apparatus wherein the image information read is subjected to image processing and then an image is formed based on the image information thus processed.

Accordingly, an image formed by such an analog image forming apparatus directly reflects the strain and aberration of the reflecting mirror, through-lens and the like. For this reason, the digital image forming apparatus designed to make correction for such strain and aberration are generally considered to provide better printing quality.

Since such a digital image forming apparatus follows the procedure in which image information read in the scanner section is temporarily saved in the control section and then transferred to the image forming section to form an image, it is also possible for the digital image forming apparatus to form an image based on image information transmitted from terminal equipment connected thereto via a network.

With the digital image forming apparatus, an image formed based on such image information transmitted from the terminal equipment is superior in print quality to that formed based on image information obtained in the scanner section.

The former is usually superior to the latter because the image information transmitted from the terminal equipment is directly processed by the image forming section, whereas the image information obtained in the scanner section, as it contains the strain and the like of the optical system, is processed by the image forming section.

In the case where additional printing is desired of the same image as has been formed in response to a print request made from the terminal equipment to the a digital image forming apparatus, a method is employed of retransmitting the print request from the terminal equipment to the image forming apparatus. When the image forming apparatus is installed remotely from the terminal equipment, it would be more convenient if an additional print request is made at a place where the recording sheet bearing the formed image can be checked, i.e., the site where the image forming apparatus is installed. Various methods have heretofore been proposed to solve this problem.

For example, a first method includes: scanning of an image formed on a recording sheet by the image forming apparatus at the place where the recording sheet bearing the image has been obtained; and subjecting the image information thus obtained to image processing such as strain correction to form an addition print of the image. This method is what is called “copy to copy” method.

A second method includes printing on a recording sheet a list of images extracted based on retrieval conditions inputted. Each of these images is provided with a selection mark writing area. The user writes a selection mark in this area, followed by scanning of the recording sheet. The image forming apparatus recognizes the image specified by the selection mark and prints the image additionally (see Japanese Patent Laid-Open Publication No. 2003-99467.)

A third method includes accumulatively storing document image data items attached with respective document IDs in printing out document images attached with respective document ID marks (the front covers of the documents). When there is an image to be additionally printed, scanning is made of the document having that image to read the document ID mark attached thereto and then the document image data item identified by the mark is read for printing (see Japanese Patent Laid-Open Publication No. HEI 10-308868.)

However, the first method involves a problem that the image formed thereby is inferior in print quality to an image formed based on the image information transmitted from the terminal equipment.

The second method involves a problem that much time and labor is required for operations including: inputting retrieval conditions; printing a list of images; writing the selection mark; scanning for finding the mark; and like operations. Also, the second method has the problem that an additional recording sheet for recording the list of images is needed.

The third method has a problem that the ID mark, which would otherwise be unnecessary, is printed on a recording sheet undesirably. Another problem with the third method is that the control section needs to perform complicated processing since the control section has to manage document image data items as connected with respective document IDs and perform encoding and decoding between document IDs and document ID marks.

A feature of the present invention is to provide an image forming apparatus capable of forming an additional print of an image by a simple operation without degrading the print quality.

### SUMMARY OF THE INVENTION

The present invention is characterized by comprising:
an image input section operative to obtain a first image information item transmitted from terminal equipment connected thereto via a network;
a storage section operative to store therein the first image information item obtained by the image input section;
an image reading section operative to obtain a second image information item by scanning an image of a document;
a control section operative to compare the second image information item obtained by the image reading section to the first image information item stored in the storage section and then select one of the first image information item and the second image information item in a manner that the first image information item is selected if the second image information item is judged to be same as the first image information item while the second image information item selected if the second image information item is judged to be different from the first image information item; and
an image forming section operative to form an image based on the image information item selected by the control section.

With this configuration, when it is desired to additionally form the same image as has been formed by the image forming section based on the first image information item transmitted from the terminal equipment, the process proceeds as follows: the image reading section scans the image having been formed to read the image information item corresponding thereto; the control section reads out of the storage section the same image information item as read by the image reading section (the first image information); and the image forming section forms an additional print of the image based on the first image information.

In an embodiment of the present invention, the control section is operative to compare the second image information item to the first image information item in their respective entire image areas. In an alternative embodiment, the control section is operative to compare the second image information item to the first image information item in their respective predetermined image areas. In a yet alternative embodiment, the control section is operative to compare the second image information item to the first image information item as to a predetermined color in their respective entire or predetermined image areas.

In another embodiment of the present invention, the image forming apparatus further includes an operating section operative to receive input operations for inputting image forming conditions for the image to be formed by the image forming section, wherein provided that: the second image information item is judged to be the same as the first image information item by the control section; and no input operation is received by the operating section, the image forming section forms the image under image forming conditions connected with the first image information item.

With this arrangement, when the first image information item transmitted from the terminal equipment is stored in the storage section, the image forming conditions for the first image information item are brought into connection with the first image information item and stored in the storage section. In the case where: the second image information item is judged to be the same as the first image information and, hence, the image is to be formed based on the first image information item; and no input operation is received by the operating section, the image forming section forms the image under image forming conditions connected with the first image information item.

In another embodiment of the present invention, if the second image information item is judged to be the same as the first image information item, the control section judges whether or not a password inputted from the operating section is identical with a predetermined password; and if the password inputted from the operating section is judged to be identical with the predetermined password, the image forming section forms the image.

In another embodiment of the present invention, the first image information item stored in the storage section is erased after lapse of a predetermined time period from the time the first image information item is put into the storage section. In this case the image forming apparatus may be configured not to erase a specified first image information item of first image information items stored in the storage section even after lapse of the predetermined time period from the time the specified first image information item is put into the storage section.

In another embodiment of the present invention, the image forming apparatus further includes a display section operative to display a list of first image information items stored in the storage section, wherein the image forming section is operative to form the image based on any one of the first image information items selected from the list by an input operation received by the operating section.

The foregoing and other features and attendant advantages of the present invention will become more apparent from the reading of the following detailed description of the invention in conjunction with the accompanying drawings.

### BRIEF DESCRIPTION OF THE DRAWINGS

FIG. 1 is a perspective overview of an image forming apparatus embodying the present invention;

FIG. 2 is a schematic sectional view showing the construction of the image forming apparatus shown in FIG. 1;

FIG. 3 is a block diagram schematically showing the configuration of a control section of the image forming apparatus shown in FIG. 1;

FIG. 4 is a flowchart showing part of a process performed by the control section of the image forming apparatus shown in FIG. 1;

FIG. 5 is a flowchart showing part of the process performed by the control section of the image forming apparatus shown in FIG. 1;

FIG. 6 is a flowchart showing part of the process performed by the control section of the image forming apparatus shown in FIG. 1; and

FIGS. 7(A) to 7(C) are each a diagram illustrating a method of comparison.

### DETAILED DESCRIPTION OF THE PREFERRED EMBODIMENTS

Hereinafter, image forming apparatus 1 embodying the present invention will be described with reference to the accompanying drawings.

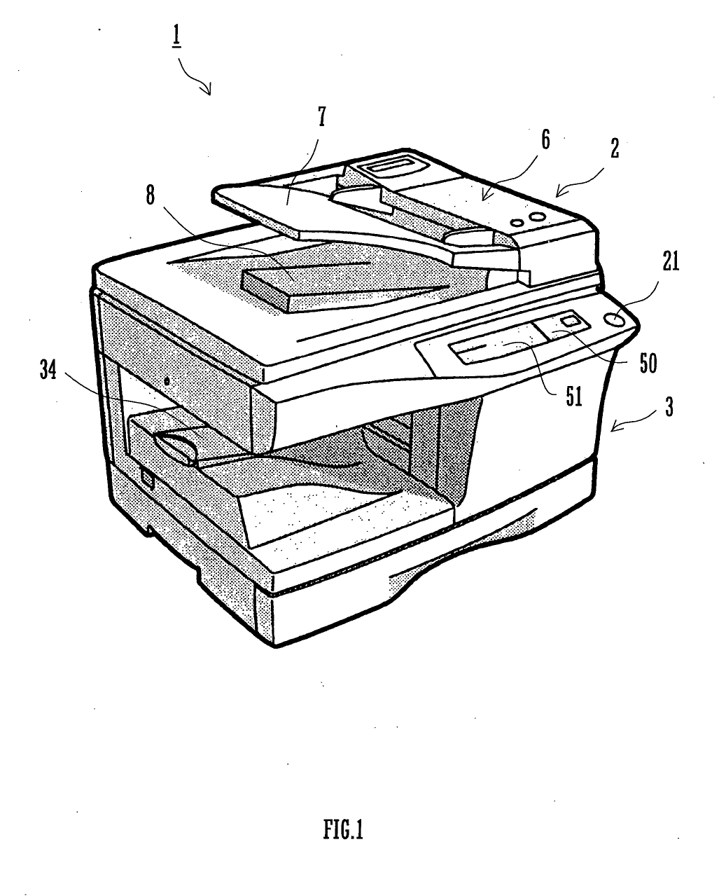

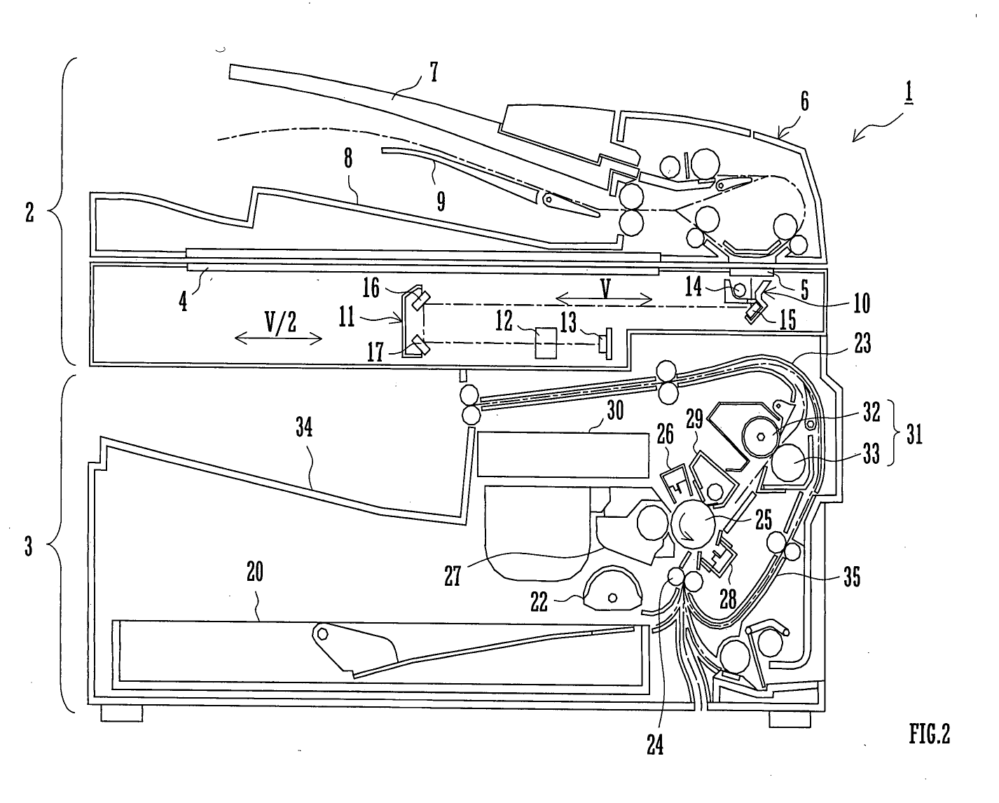

FIG. 1 is a perspective overview of the image forming apparatus 1, and FIG. 2 is a schematic sectional view showing the construction of the image forming apparatus 1. The image forming apparatus 1 is a digital composite machine having a copier mode, a printer mode and a FAX mode.

The image forming apparatus 1 includes an image reading section 2 and an image forming section 3. The image reading section 2 includes platens 4 and 5, on each of which document sheets are to be placed one by one. Above the platens 4 and 4 are disposed an automatic document feeder 6. The automatic document feeder 6 includes a document tray 7. One or more document sheets are placed on the document tray 7. In the image forming apparatus 1, a document is placed on either the platen 4 or the document tray 7 selectively.

The automatic document feeder 6 feeds document sheets in one of a one-side reading mode and a both-side reading mode selectively. In the one-side reading mode, document sheets placed on the document tray 7 are passed over the platen 5 and then ejected onto an ejected document tray 8 one by one. In the both-side reading mode, document sheets placed on the document tray 7 are transported to an intermediate tray 9 via the platen 5 one by one, and then each of the document sheets is turned upside down by inversion of its transporting direction, passed over the platen 5 again, and ejected onto the ejected document tray 8.

Below the platens 4 and 5 are disposed a first scanner 10, a second scanner 11, an imaging lens 12, and a CCD sensor 13. The first scanner 10 travels at a velocity of V in the secondary scanning direction, which is parallel with the platens 4 and 5. The second scanner 11 travels at a velocity of V/2 in the secondary scanning direction in cooperation with the first scanner 10.

The first scanner 10 includes an exposure lamp 14 and a first reflecting mirror 15. The second scanner 11 includes a second reflecting mirror 16 and a third reflecting mirror 17. Light outgoing from the exposure lamp 14 and then reflected by a document sheet is deflected by the first, second and third mirrors 15, 16 and 17 and becomes incident on the imaging lens 12. The imaging lens 12 causes the light incident thereon to form an image on the CCD sensor 13. The CCD sensor 13 in turn performs photoelectric conversion of the light forming the image thereon to read it as an image data item.

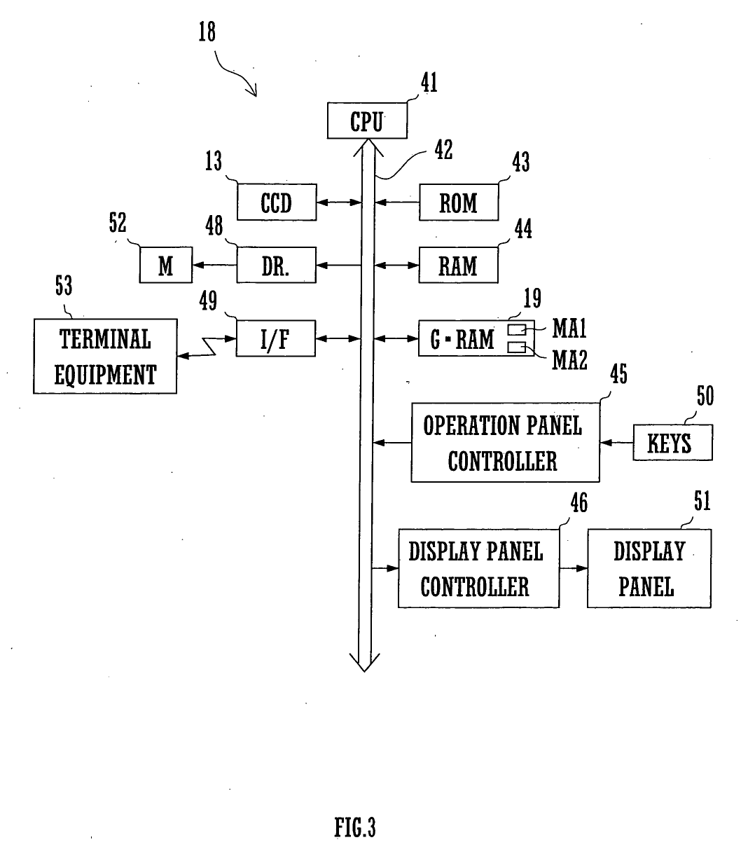

The image data item thus read is subjected to predetermined image processing by a control section 18 (see FIG. 3) to be described later and then stored in graphic RAM 19.

The image forming section 3 is disposed under the image reading section 2. On the bottom of the image forming section 3 is disposed a sheet feed tray 20. The sheet feed tray 20 holds plural recording sheets thereon. A feed roller 22 feeds each of the recording sheets onto a sheet feed path 23 in response to a depression of a start key 21 in the copier mode or in response to a receipt of a print request in the printer mode or the FAX mode. The recording sheet thus fed stands by at register rollers 24 with its leading edge caught between the register rollers 24.

Further, a photosensitive drum 25 is disposed above the sheet feed path 23. The photosensitive drum 25 is rotated counterclockwise in FIG. 2. Around the photosensitive drum 25 are arranged an electrostatic charger 26, a developing device 27, a transfer device 28, and a cleaning unit 29 in this order along the direction of rotation of the photosensitive drum 25. An LSU (Laser Scanning Unit) 30 is disposed to face the photosensitive drum 25 through the space defined between the electrostatic charger 26 and the developing device 27.

The image forming section 3 thus structured forms an image on a recording sheet through an electrostatic image forming process comprising the following charging step, exposure step, developing step, transfer step, and fixing step.

The electrostatic charger 26 electrostatically charges the outer peripheral surface of the photosensitive drum 25 to a predetermined potential (charging step). The LSU 30 irradiates the outer peripheral surface of the photosensitive drum 25 electrostatically charged to the predetermined potential with laser light modulated according to an image data item inputted thereto from the control section 18 to form an electrostatic latent image (exposure step). The electrostatic latent image formed on the outer peripheral surface of the photosensitive drum 25 is visualized into a toner image by the developing device 27 (developing step).

The recording sheet on standby with its leading edge caught between the register rollers 24 is transported to between the photosensitive drum 25 and the transfer device 28 with such timing to register the leading edge of the recording sheet with the leading edge of the toner image, so that the toner image is transferred to the recording sheet (transfer step). The cleaning unit 29 collects residual toner remaining on the photosensitive drum 25.

The recording sheet bearing the toner image transferred thereto is further transported to the fixing device 31 along the sheet feed path 23. The fixing device 31 includes a heating roller 32 and a pressure roller 33. The toner adhering to the recording sheet transported to the fixing device 31 is fixed thereto by being fused to the recording sheet under heat and pressure by means of the heating roller 32 and the pressure roller 33 (fixing step).

The recording sheet having passed through the fixing device 31 is further transported on the sheet feed path 23 and then ejected onto an ejected sheet tray 34. When it is desired to print the both sides of the recording sheet with respective images, the recording sheet having passed through the fixing device 31 is transported inversely along an inverted sheet feed path 35 and then again caught between the register rollers 24 in a state turned upside down. Thereafter, the recording sheet is passed between the photosensitive drum 25 and the transfer device 28 with predetermined timing and then passed through the fixing device 31, so that the image is formed on the reverse side of the recording sheet also. The recording sheet formed with the respective images on the both sides thereof is ejected onto the ejected sheet tray 34.

Description will be made of the configuration of the control section 18 with reference to FIG. 3. FIG. 3 is a block diagram schematically showing the configuration of the control section 18. The control section 18 includes a CPU 41 to which are connected ROM 43, RAM 44, graphic RAM 19, operation panel controller 45, display panel controller 46, CCD sensor 13, motor driver 48, and communications interface 49 via bus 42.

The CPU 41 performs various operations including image processing. The ROM 43 has stored therein a predetermined program. The RAM 44 functions as a work area for the CPU 41. The graphic RAM 19 stores image data items therein. The operation panel controller 45 is connected to keys 50 by which printing conditions, such as a number of copies, a recording sheet size and a print magnification, as well as a password and the like are inputted to the CPU 41 via the operation panel controller 45. The display panel controller 46 is connected to a display panel 51 for displaying various information items.

The CCD sensor 13 performs photoelectric conversion of optical signals obtained by scanning of a document image into an image data item A1 comprising digital signals. The image data item A1 obtained at the CCD sensor 13 is inputted to the CPU 41. The CPU 41 in turn performs predetermined image processing, such as strain correction, on the image data item A1 to obtain an image data item A2, which in turn is stored in a predetermined memory area MA1 of the graphic RAM 19.

The motor driver 48 is connected to a motor 52 operative to move the first and second scanners 10 and 11 in the secondary scanning direction according to instructions from the CPU 41.

The communications interface 49 is connected to terminal equipment 53 via a network. The terminal equipment 53 transmits a print request and an image data item B to the image forming apparatus 1. The print request and the image data item B thus transmitted are stored in a predetermined memory area MA2 of the graphic RAM 19 through the communications interface 49.

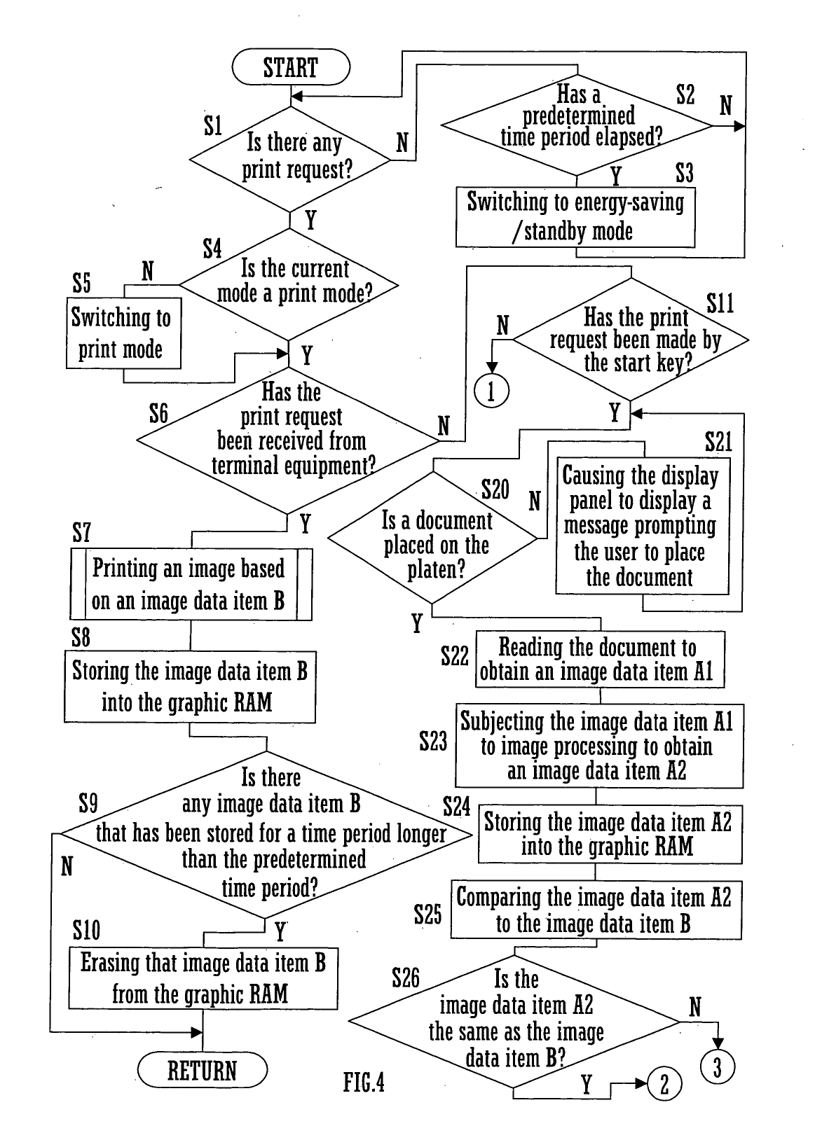

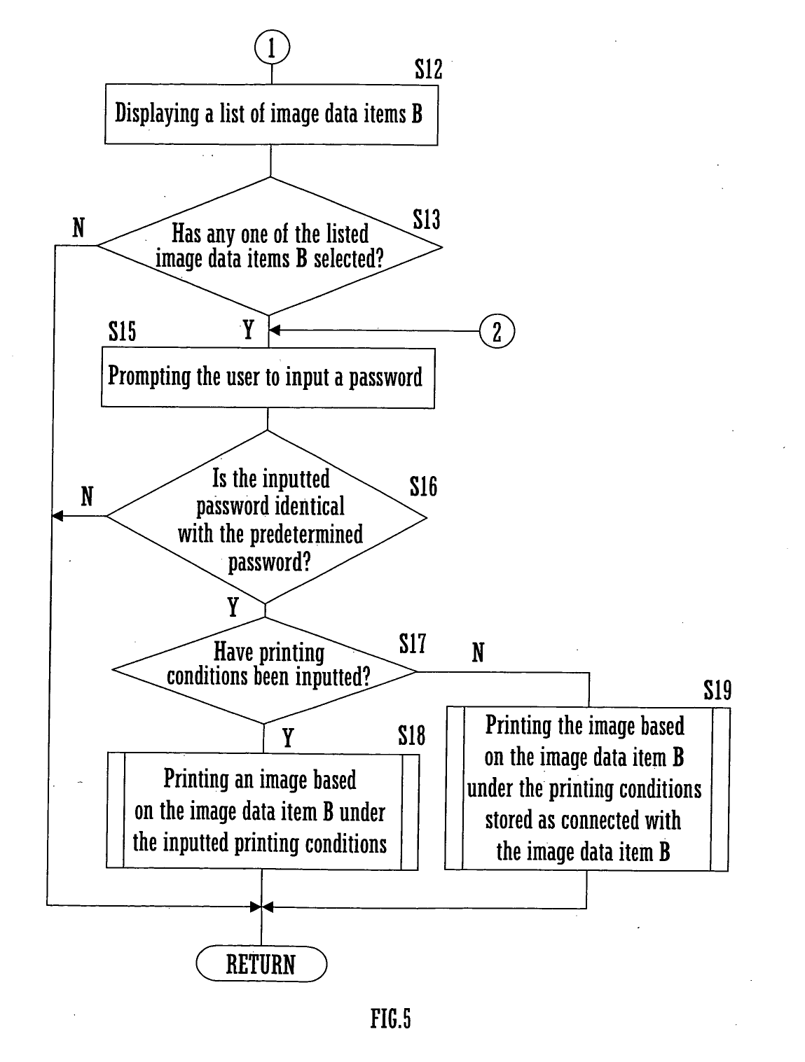

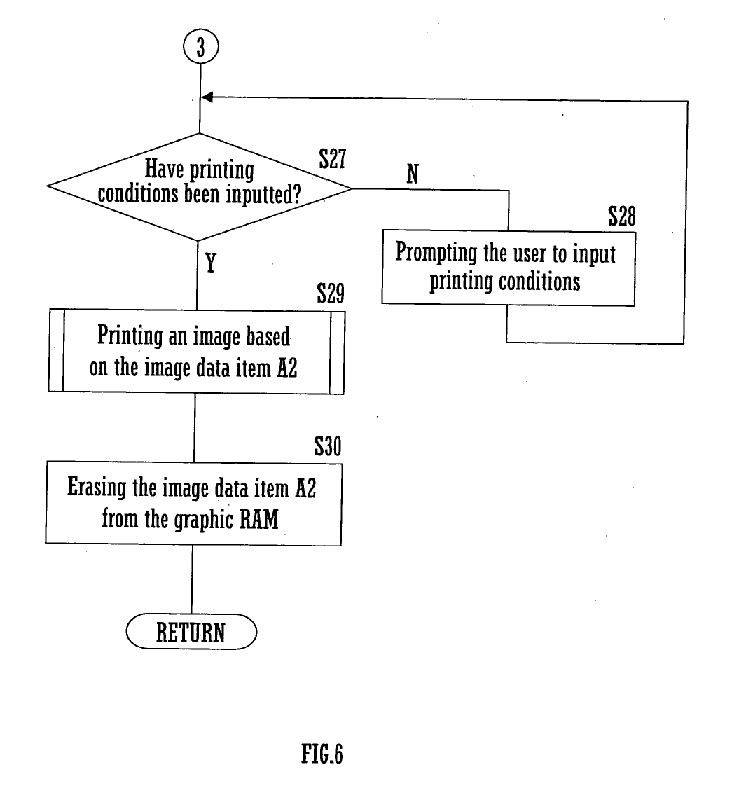

Description will be made of a process performed by the control section 18 with reference to FIGS. 4 to 6, each of which is a flowchart showing part of the process performed by the control section 18.

First, judgment is made of whether or not a print request has been made to the image forming apparatus 1 (S1). If the print request has not been made, judgment is made of whether a predetermined time period has elapsed from the last printing (S2). If the predetermined time period has not yet elapsed from the last printing, the image forming apparatus 1 stands by in a print mode. On the other hand, if the predetermined time period has elapsed from the last printing, the image forming apparatus 1 is switched into an energy-saving/standby mode (S3) and the process returns to step S1.

If it is judged that the print request has been made at step S1, judgment is made of whether or not the image forming apparatus is in the print mode (S4). If the image forming apparatus 1 is in the print mode, the process proceeds to step S6, whereas if the apparatus 1 is not in the print mode, the process proceeds to step S6 after the current mode of the image forming apparatus 1 has been switched to the print mode (S5). Subsequently, judgment is made of whether or not the print request has been inputted from the terminal equipment 53 (S6). If it is judged that the print request has been inputted from the terminal equipment 53, an image is formed on a recording sheet based on image data item B inputted from the terminal equipment 53 (S7). The image data item B inputted from the terminal equipment 53 is stored into the memory area MA2 of the graphic RAM 19 (S8). Also, data on the printing conditions transmitted together with the image data item B is brought into connection with the image data item B and stored into the memory area MA2.

In turn, judgment is made of whether or not one or more image data items B stored in the memory area MA2 of the graphic RAM 19 include that image data item B which has been stored for a time period longer than the predetermined time period (S9). If it is judged that no such image data item B exists, the process returns to START. On the other hand, if it is judged that such an image data item B exists, that image data item B is erased from the memory area MA2 of the graphic RAM 19 (S10) and then the process returns to START.

If it is judged that the print request inputted has not been received from the terminal equipment 53, judgment is made of whether or not the print request has been made by a depression of the start key 21 as an instruction to start the operation in the copier mode (S11). If it is judged that the print request has not been made by a depression of the start key 21, that is, if it is judged that the print request has been made by a depression of a non-illustrated list display key, a list of one or more image data items B stored in the memory area MA2 of the graphic RAM 19 is prepared and displayed on the display panel 51 (S12).

Subsequently, judgment is made of whether or not any one of the listed image data items B has been selected (S13). If the list does not include a desired image data item, that is, if none of the listed image data items B has been selected by the user, the process returns to START. If the list includes a desired image data item B, that is, if any one of the listed image data items B has been selected by the user, the display panel 51 displays a message prompting the user to input a password (S15). The password is inputted from the keys 50 of the operation panel 50. Subsequently, judgment is made of whether or not the password inputted is identical with the predetermined password (S16). If the inputted password is not identical with the predetermined password, the process returns to START without carrying out printing.

If the inputted password is identical with the predetermined password, judgment is made of whether or not an input has been made of printing conditions (S17). If it is judged that the printing conditions have been inputted, an image is printed based on the selected image data item B under the inputted printing conditions (S18). If it is judged that the printing conditions have not been inputted, an image is printed based on the selected image data item B under the printing conditions stored as connected with the selected image data item B (S19).

If it is judged at step 11 that the print request inputted has been made by a depression of the start key 21, the copier mode operation starts and judgment is made of whether or not a document is placed on the platen 4 or the document tray 7 (S20). If it is judged that the document is placed on the platen 4 or the document tray 7, the display panel 51 displays a message prompting the user to place the document on the platen 4 or the document tray 7 (S21), and the process returns to START.

If it is judged that the document is placed on the platen 4 or the document tray 7, the image reading section 2 reads the image of the document to obtain an image data item A1 (S22). When the image data item A1 is obtained, the control section 18 performs predetermined image processing, such as strain correction, on the image data item A1 to obtain an image data item A2 resulting from the image processing (S23). The image data item A2 thus obtained is stored in the memory area MA1 of the graphic RAM 19 (S24). Subsequently, the image data item A2 is compared to one or more image data items B stored in the memory area MA2 of the graphic RAM 19 (S25).

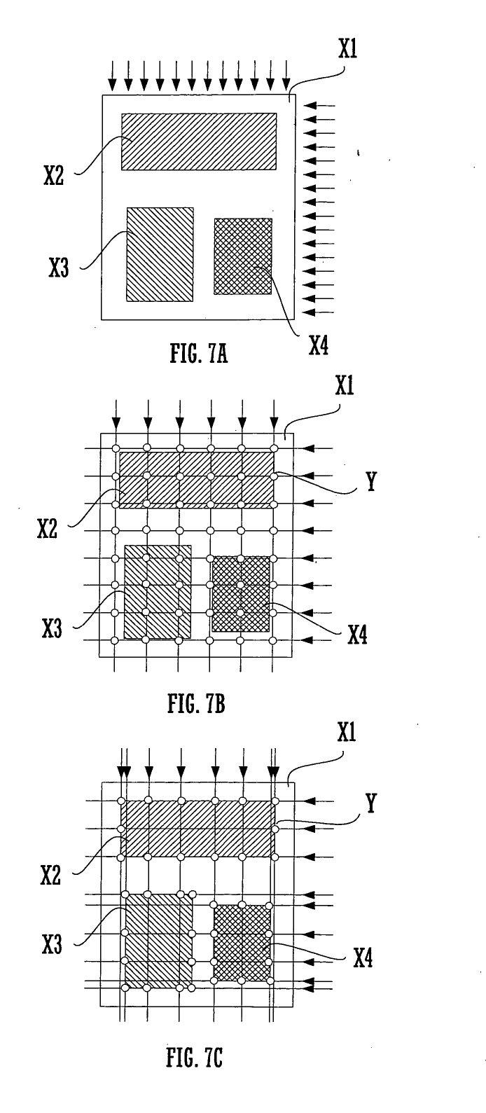

Applicable methods of comparing the image data item A2 to each of the image data items B include, for example, a total comparison method, a point (predetermined area) comparison method, and a color comparison method. FIGS. 7(A) to 7(C) are each a diagram illustrating such a method of comparison. In these figures, reference characters X1, X2, X3 and X4 designate an image area, a character image, a halftone image and photographic image, respectively. Reference character Y designates a point of comparison. According to the total comparison method as shown in FIG. 7(A), the image based on the image data item A2 and the image based on the image data item B are compared to each other as to brightness and gray level of each color in their respective entire image areas. The total comparison method is capable of correctly judging the identity between the image data item A2 and the image data item B.

According to the point comparison method, the image based on the image data item A2 and the image based on the image data item B are compared to each other as to brightness and gray level of each color at predetermined points only. Methods of establishing such points to be used in the point comparison include, for example, a method wherein vertically and horizontally equispaced points are established as shown in FIG. 7(B), and a method wherein ends of each image in an image area are detected and plural points are selected from the points on these ends as shown in FIG. 7(C). With the point comparison method, the images are compared to each other in limited areas and, hence, the amount of information to be processed is limited. For this reason, the control section 18 can use RAM 44 having a decreased capacity and is capable of completing the required processing in a shortened time.

According to the color comparison method, the image based on the image data item A2 and the image based on the image data item B are compared to each other as to predetermined colors in their respective entire image areas or at predetermine points. For example, the images are compared to each other as to one or two colors. With the color comparison method, the images are compared to each other as to colors limited in number and, hence, the amount of information to be processed is limited. For this reason, the control section 18 can use RAM 19 having a decreased capacity and is capable of completing the required processing in a shortened time.

Judgment is made of whether or not the image data item A2 and the image data item B are identical with each other by comparison according to any one of the above-described methods (S26). If it is judged that the image data item A2 and the image data item B are identical with each other, a prompt is made for an input of the password (S15) and then judgment is made of whether or not the password inputted is identical with the predetermined password (S16). If it is judged that the inputted password is not identical with the predetermined password, the process returns to START without carrying out printing.

If the inputted password is identical with the predetermined password, judgment is made of whether or not an input has been made of printing conditions (S17). If it is judged that the printing conditions have been inputted, an image is printed based on the image data item B under the inputted printing conditions (S18). If it is judged that the printing conditions have not been inputted, an image is printed based on the image data item B under the printing conditions stored as connected with the image data item B (S19).

If it is judged at step 26 that the image data item A2 and the image data item B are not identical with each other, judgment is made of whether or not an input has been made of printing conditions (S27). If it is judged that the printing conditions have not been inputted, the display panel 51 displays a message prompting the user to input the printing conditions (S28) and then the process returns to step 27.

If it is judged that the printing conditions have been inputted, an image is formed based on the image data item A2 under the printing conditions inputted (S29) and, thereafter, the image data item A2 is erased from the graphic RAM 19 (S30).

When it is desired to additionally print the same image as has been formed based on an image data item B transmitted from the terminal equipment 53, the image forming apparatus 1 can additionally print the image based on the image data item B stored in the graphic RAM 19 by causing the image reading section 2 to scan the image having been printed. Therefore, this embodiment allows the user to cause the image forming apparatus 1 to additionally print the same image as has been printed thereby based on the original image data item B by easy operation without degrading the print quality at the place where the user has checked the image precedently formed by the image forming apparatus 1. Accordingly, it is not necessary for the user to return to the terminal equipment 53 in order to retransmit the image data item B.

In forming an image based on an image data item B judged to be identical with an image data item A2 on condition that no input of printing conditions has been made from the keys 50, the image is formed under the printing conditions stored as connected with the image data item B. Thus, the image forming apparatus 1 is capable of forming the same image as has been formed based on the image data item B transmitted from the terminal equipment 53, for example, on a recording sheet of the same size and at equal magnification without the need for the operation of inputting printing conditions from the keys 50.

Since the inputting of a password is an essential condition in printing using an image data item B stored in the graphic RAM 19, the confidentiality of the image data B can be enhanced. The confidentiality of the image data B can be further enhanced by the erasure of an image data item B that has been stored in the graphic RAM 19 for a time period longer than the predetermined time period, thereby preventing leakage of the image data item B. Further, the graphic RAM 19 can have an increased available memory capacity, which means that the memory capacity of the graphic RAM 19 can be reduced.

An image data item B of particularly high necessity, which is for highly frequent use for example, can be retained even after lapse of the predetermined time period from the time it is put into storage. Thus, the image forming apparatus 1 can keep high confidentiality without loss of convenience.

A desired image data item B can be selected from a list of image data items B when such selection is convenient to the user, which results in increased variations of the method of selecting a desired image data B from one or more image data items B stored in the graphic RAM 19.

The foregoing embodiment allows the user to cause the image forming apparatus to additionally form the same image as has been printed thereby based on the original image information item by easy operation without degrading the print quality at the place where the user has checked the image precedently formed by the image forming apparatus. Therefore, it is not necessary for the user to return to the terminal equipment in order to retransmit the first image information item.

In the above additional formation of an image, the image forming apparatus is capable of forming the same image as has been formed based on the first image information item transmitted from the terminal equipment, for example, on a recording sheet of the same size and at equal magnification without the need for the operation of inputting image forming conditions from the operating section.

The confidentiality of the image information stored in the storage section can be enhanced by the use of a password and/or the erasure of a first image information item that has been stored in the storage section for a time period longer than the predetermined time period.

Further, a desired first image information item can be selected from a list of first image information items when such selection is convenient to the user, which results in increased variations of the method of selecting a desired first image information item from one or more first image information items stored in the storage section.

While only certain presently preferred embodiments of the present invention have been described in detail, as will be apparent for those skilled in the art, certain changes and modifications may be made in embodiments without departing from the spirit and scope of the present invention as defined by the following claims.

1. An image forming apparatus comprising:
an image input section operative to obtain a first image information item transmitted from terminal equipment connected thereto via a network;
a storage section operative to store therein the first image information item obtained by the image input section;
an image reading section operative to obtain a second image information item by scanning an image of a document;
a control section operative to compare the second image information item obtained by the image reading section to the first image information item stored in the storage section and then select one of the first image information item and the second image information item in a manner that the first image information item is selected if the second image information item is judged to be same as the first image information item while the second image information item selected if the second image information item is judged to be different from the first image information item; and
an image forming section operative to form an image based on the image information item selected by the control section.

2. The image forming apparatus according to claim 1, wherein the control section is operative to compare the second image information item to the first image information item in their respective entire image areas.

3. The image forming apparatus according to claim 1, wherein the control section is operative to compare the second image information item to the first image information item in their respective predetermined image areas.

4. The image forming apparatus according to claim 1, wherein the control section is operative to compare the second image information item to the first image information item as to a predetermined color in their respective entire or predetermined image information areas.

5. The image forming apparatus according to claim 1, further comprising an operating section operative to receive input operations for inputting image forming conditions for the image to be formed by the image forming section, wherein
provided that: the second image information item is judged to be the same as the first image information item by the control section; and no input operation is received by the operating section, the image forming section forms the image under image forming conditions connected with the first image information item.

6. The image forming apparatus according to claim 5, wherein: if the second image information item is judged to be the same as the first image information item, the control section judges whether or not a password inputted from the operating section is identical with a predetermined password; and if the password inputted from the operating section is judged to be identical with the predetermined password, the image forming section forms the image.

7. The image forming apparatus according to claim 1, wherein the first image information item stored in the storage section is erased after lapse of a predetermined time period from the time the first image information item is put into the storage section.

8. The image forming apparatus according to claim 7, wherein a specified first image information item of first image information items stored in the storage section is not erased even after lapse of the predetermined time period from the time the specified first image information item is put into the storage section.

9. The image forming apparatus according to claim 5, further comprising a display section operative to display a list of first image information items stored in the storage section, wherein
the image forming section is operative to form the image based on any one of the first image information items selected from the list by an input operation received by the operating section.
